(19) United States
(12) Patent Application Publication
(10) Pub. No.: US 2003/0225567 A1
(43) Pub. Date: Dec. 4, 2003

(54) System and method for emulating an embedded non-volatile memory

(76) Inventors: Stefan Marco Koch, Zurich (CH); Hans-Joachim Gelke, Zurich (CH); Axel Hertwig, Nurnberg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/379,320

(22) Filed: Mar. 4, 2003

(30) Foreign Application Priority Data
Mar. 9, 2002 (EP) 02005486.2

(51) Int. Cl. G06F 9/455

(52) U.S. Cl. 703/24

(57) ABSTRACT

The system and method for emulating a non-volatile memory, in particular a flash memory, embedded in an integrated circuit comprises an integrated circuit with the non-volatile memory, a processor, an interface, a control unit, which controls the embedded non-volatile memory and the interface, and a bus, which connects controllably the interface, the processor and the control unit. The system further comprises an external memory, connected to the interface, in which memory the emulation takes place. The control unit connects the external memory to the bus over the interface or the non-volatile memory to the bus. By using such a design, emulation of a slow embedded (internal) memory is simplified and modifications, e.g. software break points, patches and downloads, can be easily introduced, and processor accesses may be traced.

The invention relates to a system and a method for emulating a non-volatile memory. Embedded non-volatile memories are state of the art features in complex processor and multi-processor systems. This invention describes the real-time emulation solution for a single processor or a multi-processor system with embedded non-volatile memory.

During the development of software for a real-time system with embedded non-volatile memory, the following problems occur: the internal memory size is limited; software break points, patches and software downloads are difficult to apply; the accesses to integrated memory are not visible externally; and the content of the internal memory cannot be scanned for real-time tracking of variables.

Present state of the art integrated circuit (IC) solutions do not offer real-time emulation for embedded non-volatile memory. Embedded non-volatile memory, like large arrays of flash memory, attached to high performance processors, behaves in a complex, timely unpredictable way. There are several reasons for it. One is for controlling the flash memory there is a flash shell necessary. The cashing inside the flash shell makes the behavior complex and timely unpredictable. A second reason is the difference in the timings between an external SRAM and an embedded flash memory. A third one is the multi-processor access to the same memory.

From the stade of the art U.S. Pat. No. 4,277,827 is known a microprocessor based system for the development and emulation of programmable calculator control read only memory (CROM) software for use in conjunction with programmable calculators and the like. The development system operates as two independent yet integrated systems. The system generates programmable calculator key codes from source code entered via a system computer keyboard, then maps the code into the system's read/write RAM in the proper CROM format, and generates a gate placement tape from data stored in that memory. Additionally the system emulates a CROM for real time interconnection to the programmable calculator. Thus, actual in calculator testing of the generated key codes is made possible prior to commitment of the code to mask and permanent manufactured CROMs. However a disadvantage of this system is, that the building blocks are boards and not integrated circuits and that it is not applicable to integrated circuits. The solution has no real-time behavior. In case of emulation the board setup of the microprocessor based system changes. Therefore said system is not able to be used in emulation mode and normal mode.

Therefore the main object of the present invention is to provide a system and a method for emulating a non-volatile memory which allows in an integrated circuit the tracing of the internal processor access in a easy way.

Moreover a second object of the invention is to provide a much bigger memory space than it is usually available internally. This is helpful particularly at the development of software.

A third object of the invention is to adapt an internal memory interface, which can be non-standard and proprietary to a specific vendor, to an external memory interface protocol, which is standard, providing accessibility for many debugging tools.

The solution according to the invention is a system for emulating a non-volatile memory with the features according to claim 1 and by a method for emulating a non-volatile memory with the features according to claim 12.

The system for emulating a non-volatile memory related to the invention comprises an integrated circuit; the integrated circuit in turn comprises the non-volatile memory, a processor, an interface, a control unit, which controls the embedded non-volatile memory and the interface, and a bus, which connects the interface and the processor to the control unit. The system further comprises an external memory, which can be connected to the interface, wherein the control unit connects optionally the external memory to the bus over the interface or the non-volatile memory to the bus.

The method for emulating a non-volatile memory with an integrated circuit comprises the non-volatile memory, a processor, an interface, a control unit and a bus, wherein the embedded non-volatile memory and the interface are controlled by the control unit, wherein the interface and the processor get connected to the control unit by the bus, with an external memory, which can be connected to the interface, and wherein the external memory gets connected to the bus over the interface or the non-volatile memory to the bus by the control unit.

Advantageous further developments of the invention will be seen from the features indicated in the dependent claims.

In another embodiment of the invention, the integrated circuit comprises a further processor, a further interface, a further bus, over which the further interface, the further processor and the control unit are connected together, and a further external memory, which can be connected to the further interface. The control unit connects optionally the further external memory to the bus over the interface or the non-volatile memory to the bus.

In another embodiment of the invention the external memory is an emulator or, specifically, a real-time emulator.

In a further embodiment of the invention the non-volatile memory is a flash memory.

In a still further embodiment of the invention, the integrated circuit comprises a random access memory and a random access memory control for controlling this random access memory. The random access memory can be connected to the bus over the random access memory control.

In another embodiment of the invention, the integrated circuit comprises an address decoder which is controlled by the processor and which guides a selection command to the control unit and the interface.

In another embodiment of the invention, the selection command is decoded for reading and for writing to the non-volatile memory.

In a further embodiment of the invention, the control unit creates wait states for adapting the speed of the external memory to the speed of the non-volatile memory.

In a still further embodiment of the invention, the control unit guides the wait states to the interface and the processor.

In another embodiment of the invention, the interface transmits data between the external memory and the bus during the emulation.

The invention may be applied to any integrated microprocessor system including embedded non-volatile memory. It provides significant advantages for the development of products used in systems like mobile terminals or phones, personal digital assistants (PDA), notebooks, modems, or disk drives.

In detail, the system for emulating a non-volatile memory according to the invention, has several advantages:

There is no size limitation, thus it is ideal for additional features in the software or for non-size-optimized code.

The memory can be a non-volatile memory to simplify the insertion of software break points, patches and downloads.

The processor accesses can be traced.

The memory can be dual-ported non-volatile memories as used in so-called emulators for real-time tracking of variables.

A single non-volatile memory suffices for a multiprocessor system.

The decision on how to share the non-volatile memory space can be postponed.

Subsequently, the invention is further explained by way of two embodiments together with the four following figures:

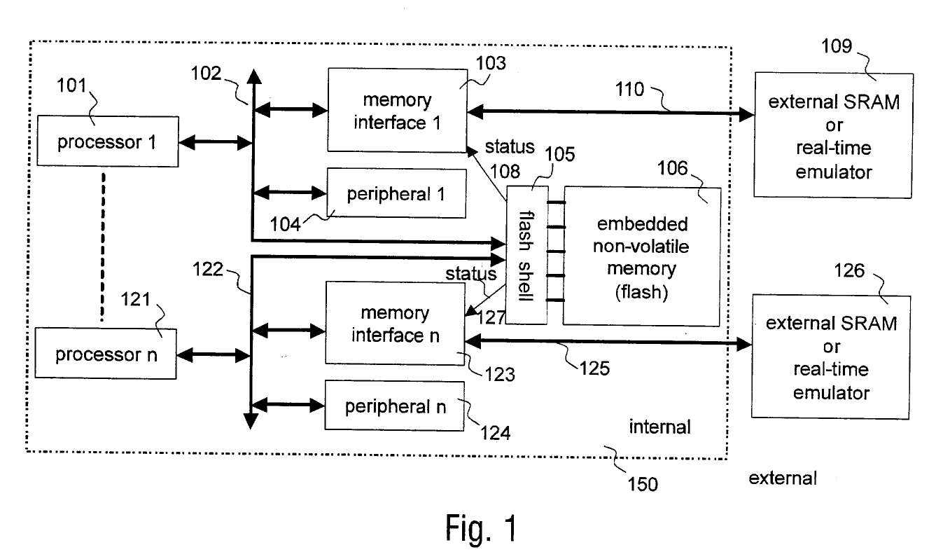

FIG. 1 shows a multi processor system for emulating a non-volatile memory according to a first embodiment of the invention;

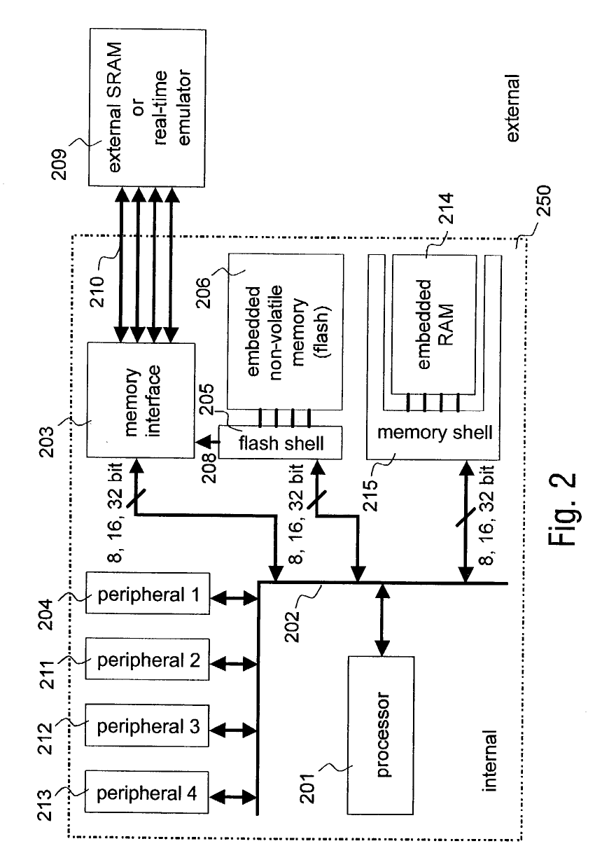

FIG. 2 depicts a single processor system for emulating a non-volatile memory with an additional embedded volatile memory according to a second embodiment of the invention; and

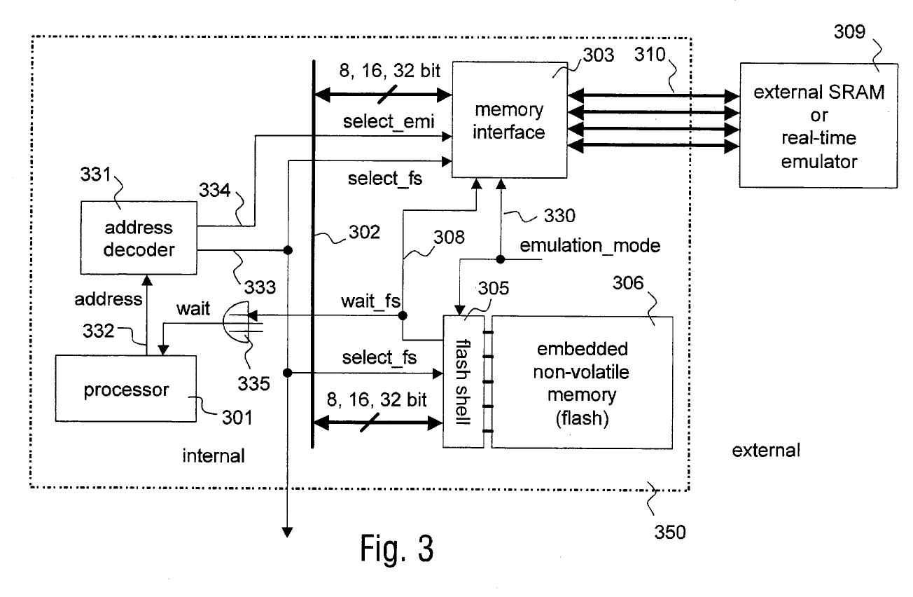

FIG. 3 shows a circuitry example of the single processor system for emulating a non-volatile memory according to the invention.

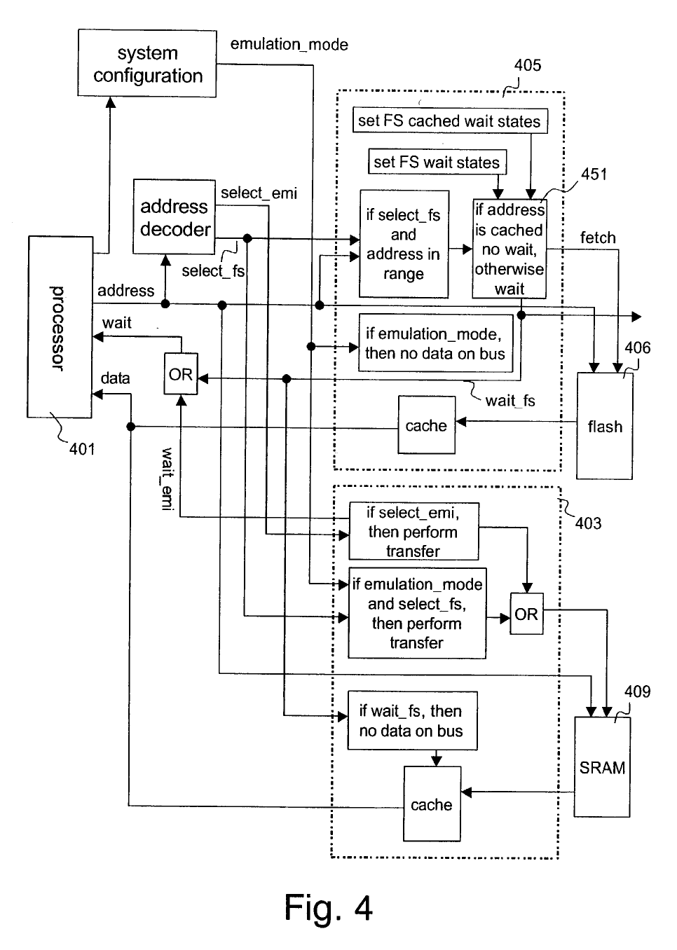

FIG. 4 shows the microprocessor system of FIG. 3 in more detail.

It must be highlighted that the same circuit supports both the normal and the emulation mode. In the normal mode the integrated circuit runs with its intended application. The processor accesses the flash shell and the external memory interface at the same time. For instance processor code is fetched from the flash memory and data are written and read to an external SRAM. During the emulation mode the integrated circuit runs the same application as in normal mode. However the functionality which is available internally in normal mode is performed with external components by means of the flash shell and the external memory interface.

The system and the method for emulating a non-volatile memory according to the invention permits the integrated circuit to run both in the normal mode and in the emulation mode in a very similar way.

Generally, it should be understood that the mapping of embedded memory (106, 206, 306, as detailed below) to the external world necessitates taking several real-time issues into account. These issues are:

the embedded flash memory is slow compared to processor speed;

the embedded flash memory is basically an asynchronous block, therefore not synchronized to the processor:

the embedded memory is usually designed-in with wrappers (afterwards called flash shell or control unit), which can introduce non-predictable delays; and

a multi-processor access to the same instance of non-volatile memory makes the timing hardly predictable. In general it is very difficult to know in advance the exact split of the memory between the processors. The implementation of one single memory provides flexibility with this respect.

FIG. 1 shows a system for emulating a non-volatile memory according to the invention. This system comprises an integrated circuit 150, in the following also called internal system component, and external devices 109 and 126. Both the integrated circuit 150 and the external devices 109 and 126 are connected together over a first external memory interface bus 110 and a second external memory interface bus 125. The external devices 109 and 126 can be optionally a static random access memory (SRAM) or a real-time emulator. The integrated circuit 150 comprises one or several processors as internal system components. The system shown in FIG. 1 is obviously an embodiment with two processors 101 and 121. The integrated circuit 150 also comprises a first and a second internal bus 102 and 122, a first and a second peripheral 104 and 124, a first and a second memory interface 103 and 123, a flash shell 105, also called control unit, and an embedded non-volatile memory 106.

If the system for emulating a non-volatile memory according to the invention is a single processor system, only one memory interface, one external memory interface bus, and one internal bus are necessary on the integrated circuit 150.

The system drawn in FIG. 1 is generic in terms that each of the processors can have its own architecture and its own set of peripherals. Some (or all) of the processors 101, 121 are connected to the embedded non-volatile memory 106 for code and data fetches. The connection to external SRAM or to real-time emulators 109 and 126 happens through the external memory interfaces 103 and 123 in order to map the target memory of the processor 101, 121 (in this case the non-volatile memory 106) onto the external memories 109 and 126. With such a setup, an emulator can control the target memory of the emulated processor 101 and/or 121 with variable tracking or dynamic software download. The dynamic software download can be carried out without interrupting the application.

As already mentioned above, the non-volatile memory 106 embedded in the integrated circuit 150 is preferably a flash memory.

In real-time emulation, it is important that the timing of the non-volatile memory 106 to be emulated is mapped on a per cycle basis onto the emulator memory 109. This is necessary because:

The operation speed of the flash memory 106, usually in the range of 50-200 ns, differs significantly from the operation speed of the external memory 109 and 126, which is usually in the 3-10 ns range. This means that a different number of wait states must be inserted in the processor flow.

The memories 109 and 126, external to the integrated circuit 150, have a different delays compared to the embedded non-volatile memory 106 and are connected to different control signals.

In many applications, the embedded non-volatile memory 106 is used by more than one processor 101, which implies interference due to concurrent activity on the flash memory 106. This interference must be modeled.

The external memory interface 103 must emulate all accesses to the flash shell 105 in terms of access width and number of cycles per access according to the following formula in number of cycles:

access=1+waits+synchronization+interference

Some components inside the integrated circuit 150 must support real-time emulation of such a system, in terms that the timing behavior of the emulator (external) memory 109 is equivalent to the one of the embedded non-volatile memory 106. This circuitry is placed in the external memory interfaces 103 and 123 and receives status signals 107 and 127 from the flash shell 105.

The flash shell 105 also connects the embedded non-volatile memory 106 to the first and second bus 102 and 122 for data transmission from and to the non-volatile memory 106.

The peripherals 104 and 124 can be external devices, for example a universal asynchronous receiver/transmitter (UART), a flash memory, or a universal serial bus (USB).

The processors 101 and 121 can be different types or of the same type.

In the following, the behavior of the external memory interfaces 103 of FIG. 1 and 123 of FIG. 2 shall be described.

Turning to FIG. 2, in real-time emulation, a target system with an embedded volatile memory 214 and non-volatile memory 206 is connected to external SRAM or to an emulator 209. In this setup, the system can be configured to substitute the embedded memory 206 and/or the embedded random access memory 214 with the external memory 209. This means that for each access to internal non-volatile memory 206 or volatile memory 214, an access of the same width to the external emulator 209 must be performed. The number of wait states generated by the external memory interface 203 must be equal to the number of wait states introduced by an access to internal memory 206 or 214.

If the flash shell 208 is connected to more than one master or processor, the number of additional wait states introduced to the processor flow by the interference between the processors must be modeled or controlled by the external memory interface 203.

As already described, the external memory interface 203 must emulate all accesses to the flash shell 205 in terms of access width and number of cycles per access according to the following formula in number of cycles:

access=1+waits+synchronization+interference

The peripherals 204, 211, 212, 213, which are connected to the internal bus 202, can be the of the same type as described in FIG. 1.

The processor or other bus master 201 is also connected to the internal bus 202.

The embedded random access memory 214 is controlled by a memory shell 215, which also connects the embedded random access memory 214 to the internal bus 202 for data transmission from and to the random access memory 214.

The example drawn in FIG. 3 shows an implementation of the behavior described before. In normal mode, the flash shell 305 generates wait states wait_fs depending on the speed of the non-volatile memory 306. During real-time emulation, the operation hardware has to be switched (e.g. programming a register bit accordingly) via an emulation mode line emulation_mode 330 such that the flash shell 305 generates wait states wait_fs for all accesses to the flash shell address space, but the readouts are actually performed by the external memory interface 303.

The hardware impacts generated by this are minimal:

During real-time emulation, the flash shell 305 behaves “normal” whenever it is accessed. It inserts wait states wait_fs on a line 308 into the processor flow, but does not put any data onto the bus 302 (these are dummy accesses, so-to-speak).

For each access to the flash shell 305, the external memory interface 303 will put the requested data onto the bus 302. For this reason the select flash shell signal select_fs has to be connected to the external memory interface 303.

A command line 333 for a select flash shell command select_fs is connected to the external memory interface 303 in order to communicate when the flash memory 306 is accessed.

The wait state signal wait_fs is connected to the external memory interface 303 in order to make sure that the timing on the bus 302 is equivalent to the timing in normal mode.

A line 334 for selecting the external memory interface 303 is provided between the address decoder 331 and the external memory interface 303. The select external memory interface signal select_emi is used for selecting the external memory interface 303.

To make the system work, the time to read out from the emulator memory 309 through the external memory interface 303 must be faster than the readout timing of the flash memory 306 and the flash shell 305.

The flash memory 306 is comparatively slow when reading. It is furthermore much slower, when writing to it. When an application needs to access to the flash memory 306 for writing, it can store data, for example variables, user information or files, and it can add or exchange pieces of code, for example a new or a different application. Emulating the write access would normally not be done to test the write procedure itself It is more intended to see, if a part of an application is changed and if the code still works as desired. For the purpose of writing to the embedded non-volatile memory 306, the select flash shell signal select_fs needs to be decoded by the external memory interface 303 also in write direction.

FIG. 3 shows only one processor or other bus master 301 connection to the flash shell 305. In case several masters are existing, all processors must be connected to the flash shell 305, as in FIG. 1. Then the flash shell 305 must include an arbitration circuitry for the normal mode, which circuitry has to operate as arbitrator also during emulation. This is necessary to handle the interference of all the masters.

FIG. 4 shows the microprocessor system of FIG. 3 in more detail. It must be highlighted that the same circuit supports both the normal and the emulation mode. As already described in the normal mode the integrated circuit runs with its intended application. The processor or other bus master 401 accesses the flash shell 405 and the external memory interface 403 at the same time. For instance processor code is fetched from the flash memory 406 and data are written and read to an external SRAM 409. During the emulation mode the integrated circuit runs the same application as in normal mode. However the functionality which is available internally in normal mode is performed with external components by means of the flash shell 405 and the external memory interface 403. For this purpose, the select flash shell signal select_fs is both connected to the flash shell 405 and to the external memory interface 403. In emulation mode the flash memory 406 is not used. For example both processor code and application data are stored in the external memory. In the flash shell 405, the select flash shell signal select_fs activates the address decoding. If the address is in the expected range, a further circuit 451 checks whether the requested address is already cached within the flash shell 405. In case the requested address is cached, then a defined number of wait states is inserted (ideally zero). In case the requested address is not cached, then the flash shell 405 has to read out the flash memory 406. But the fetched information is not used, because in emulation mode the flash shell 405 does not put any data onto the bus. In the meantime, the processor 401 is stalled for a defined number of wait states by the signal wait. All the inserted wait states are visible in the wait state signal wait_fs which is used by the external memory interface 403 to insert the exactly same number of wait states in the external memory interface 403. The select flash shell signal select_fs activates the address decoding in the emulation mode. In this way the external memory interface 403 is performing the data fetches instead of the flash shell 405. Note that the external memory interface 403 is fully working for regular external memory access signaled by the select external memory interface signal select_emi also in the emulation mode. Therefore the external memory interface 403 also generates all necessary wait states required for its operation, signaled by wait_emi, in the emulation mode. The flash shell 405 does not drive any fetched data on the bus. The emulation mode can be set by programming a system configuration block accordingly. Usually one control signal emulation_mode would change the mode.

The invention can be applied to all integrated microprocessor systems including embedded non-volatile memory. It gives a leading advantage for several products, which are used in systems like mobile terminals or phones, personal digital assistants (PDA), notebooks, modems, disk drives, etc.

It can be helpful to make the wait state signal wait_fs available externally. The wait state signal wait_fs gives a lot of information about the size and architecture of the cache. This is a kind of performance information and provides information on the cache miss rate and the cache performance.

It should be apparent from the above that the system for emulating a non-volatile memory according to the invention provides the advantages already addressed above, namely:

Because there is no size limitation it is ideal for adding features in the software or for non-size-optimized code.

It allows employing non-volatile memory which eases the insertion of software break points, patches and downloads, in particular allows it employing dual-ported non-volatile memories as used in so-called emulators for real-time tracking of variables.

It allows tracing of processor accesses to the embedded non-volatile memory.

A single non-volatile memory suffices for any multiprocessor system.

The sharing of the non-volatile memory space between several processors can be decided anytime.

It provides information on the cache miss rate and the cache performance.

1. A system for emulating an embedded non-volatile memory with an integrated circuit (150, 250, 350) comprising:
an embedded non-volatile memory (106, 206, 306),
a processor (101, 201, 301),
an interface (103, 203, 303),
a control unit (105, 205, 305) controlling said non-volatile memory (106, 206, 306) and said interface (103, 203, 303), and
a bus (102, 202, 302) connecting said interface (103, 203, 303) and said processor (101, 201, 301) to said control unit (105, 205, 305),
the system further including an external memory (109, 209, 309) connectable to said interface (103, 203, 303) under control of said control unit (105, 205, 305).

2. The system according to claim 1, wherein the control unit (105, 205, 305) connects the external memory (109, 209, 309) to the bus (102, 202, 302) over the interface (103, 203, 303) or the non-volatile memory (106, 206, 306) to the bus (102, 202, 302).

3. The system according to claim 1 or 2, wherein the integrated circuit (150, 250, 350) comprises:
a further processor (121),
a further interface (123),
a further bus (122), over which said further interface (123), said further processor (121) and the control unit (105) are connected together,
a further external memory (126), connectable to said further interface (123), wherein said control unit (105) connects said further external memory (126) to said bus (122) over said interface (123) or said non-volatile memory (106) to said bus (122).

4. The system according to claim 1, 2 or 3, wherein the external memory (109, 209, 309, 126) is an emulator, in particular a real-time emulator.

5. The system according to any of the claims 1 to 4, wherein the non-volatile memory (109, 209, 309) is a flash memory.

6. The system according to any of the claims 1 to 5, wherein the integrated circuit (150, 250, 350) comprises a random access memory (214) and a random access memory control (215) for controlling the random access memory (214) and said random access memory control (215) is connected to the bus (202).

7. The system according to any of the preceding claims, wherein the integrated circuit (150, 250, 350) comprises an address decoder (331), which is controlled by the processor (301) and directs a selection command (select_fs) to the control unit (305) and the interface (303).

8. The system according to claim 7, wherein the selection command (select_fs) is decoded for reading and for writing to the non-volatile memory (306).

9. The system according to any of the preceding claims, wherein the control unit (305) creates wait states (wait_fs) for adapting the speed of the external memory (309) to the speed of the non-volatile memory (306).

10. The system according to claim 9, wherein the control unit (305) directs the wait states (wait_fs) to the interface (303) and the processor (301).

11. The system according to one of the claims 1 to 9, wherein during the emulation, the interface (303) transmits data between the external memory (309) and the bus (302).

12. A method for emulating an non-volatile memory embedded in an integrated circuit (150, 250, 350) comprising:
a non-volatile memory (106, 206, 306),
a processor (101, 201, 301),
an interface (103, 203, 303),
a control unit (105, 205, 305), and
a bus (102, 202, 302),
wherein
said control unit (105, 205, 305) controls said embedded non-volatile memory (106, 206, 306) and said interface (103, 203, 303), and
said interface (103, 203, 303) and said processor (101, 201, 301) are connectable to said control unit (105, 205, 305) by said bus (102, 202, 302), with an external memory (109, 209, 309) connectable to said interface (103, 203, 303),
said external memory (109, 209, 309) gets connected to said bus (102, 202, 302) over said interface (103, 203, 303) or said non-volatile memory (106, 206, 306) to said bus (102, 202, 302) by said control unit (105, 205, 305).

13. The method according to claim 12, wherein the integrated circuit (150, 250, 350) comprises:
a further processor (121),
a further interface (123),
a further bus (122), over which said further interface (123), said further processor (121) and the control unit (105) get connected together,
a further external memory (126), which may be connected to said further interface (123),
the further external memory (126) being connectable to said further bus (122) over said further interface (123) or the non-volatile memory (106) to said further bus (122) by said control unit (105).
